(19) United States
(12) Patent Application Publication
(10) Pub. No.: US 2011/0103539 A1
(43) Pub. Date: May 5, 2011

(54) RESILIENT SPACER FOR FUEL RODS OF NUCLEAR REACTORS

(76) Inventors: Horacio Agueda, San Carlos de Bariloche (AR); Mario Markiewikz, San Carlos de Bariloche (AR)

(21) Appl. No.: 12/611,683

(22) Filed: Nov. 3, 2009

(30) Foreign Application Priority Data
Nov. 3, 2009 (AR) P-08-01-04802

(51) Int. Cl. G21C 3/34

(52) U.S. Cl. 376/438

(57) ABSTRACT

A resilient spacer for nuclear fuel rods having a plurality of cells to keep the fuel rods in position. The resilient spacer includes two spaced apart grids joined together, with each grid defining cells of the plurality of cells to keep the fuel rods in position and with each cell of the plurality of cells having springs for restricting the displacement of the fuel rods. In addition, the present invention also provides a nuclear fuel element having the spacer.

### BACKGROUND OF THE INVENTION

1. Field of the Invention

This invention relates to resilient spacers for fuel elements of nuclear reactors. Specifically, and not by way of limitation, the present invention relates to a resilient or elastic spacer for nuclear rods.

2. Description of the Related Art

Ever since nuclear fuels have been used, a characteristic and distinctive element has been the different separators or spacers that are used to hold the fuel elements or rods in the appropriate position to keep the nuclear chain reaction within the reactor, to allow cooling of the fuel rods and to maintain the geometry of the fuel elements within normal and accidental operating conditions, even after nuclear use has ended.

The fuel elements are composed of a certain amount of fuel rods, whose structure varies according to different considerations, mainly thermo-hydraulic considerations. The most common examples of geometrical shapes for the rods are circular, square and hexagonal sections.

The complexity of the manufacturing of resilient separating or spacing plates and its components hinders the making of intricate parts, which requires the development of a large amount of molds for the confection of the parts, depending on the established fabrication route.

Apart from the difficulty of the weldings to be performed for circular geometries of the fuel elements, there is the additional complexity of placing longitudinal elastic springs. Although the square and hexagonal geometries facilitate the placing of the longitudinal springs, a large amount of parts must be fabricated and the weldings on each connection point of the plates on both sides of the spacer are still necessary.

As the design confronts a new fuel element, the development of the resilient spacers is often an important restrictive factor, and significant costs are required for the development as well as necessary tools to guarantee the necessary reliability of the components, which in many cases directly eliminates the possibility of using new concepts for fuel elements or achieving new geometrical arrangements in order to increase the efficiency of the use of nuclear fuel.

Some alternative methods for constructing spacers have been used in the past, such as those made through spark erosion. Although more complex shaped parts can be obtained, the loss of material and the time that is needed to make the spacers is extremely costly.

The spacers obtained through this process are restricted in the height they can achieve, which makes the placing of springs for the retention of the fuel rods impossible or immensely difficult, thus transforming them in so-called rigid spacers.

These rigid spacers present the obstacle that, to avoid the fuel rod being worn as a result of the constant friction with the rigid walls of the spacer, the design of the fuel rods and their fabrication has to be intricate, as localized reinforcements or rails have to be placed, in order to avoid this localized wear of the fuel rod and its possible breaking. This situation is not acceptable during the operation of the fuel element within nuclear reactors or during periods of storage until the final disposal of the contained residue, as in any of these cases this would allow leakage of the fission products.

Some examples of these types of spacers are shown in FIGS. 7, 8 and 9, which correspond to simplified diagrams or schemes of known spacers that are used currently in different types of available nuclear power reactors.

FIG. 7 shows a top perspective view of a typical rigid spacer made from Zircaloy, which is currently used in the nuclear reactor named “Atucha I”, in Argentina.

FIG. 8 shows a schematic top perspective view of a resilient spacer with a hexagonal arrangement developed for the “CAREM 25” reactor, that is constructed using Inconel with stamped springs on the plates that make up the spacer.

FIG. 9 shows a top perspective view of a portion of a resilient spacer with a hexagonal arrangement developed for the “CAREM 25” reactor, that is constructed using Inconel with stamped springs on the plates that make up the spacer.

The prior art mentioned above present several disadvantages. Resilient spacers made with straps require dozens of parts and, for cylindrical and hexagonal geometries, approximately one hundred fabrication steps. Their height is determined and fixed, designed for each spacer, and the behavior of the spring is limited to the height of the spacer. Spacers made from stamped plates require hundreds of weldings and, as a result, require a complex and long quality control process. They also require the realization of hundreds of molds to form the component plates. The loss of charge that each spacer causes depends on its geometry and structure which, in the case of the prior art, is difficult to reduce.

### SUMMARY OF THE INVENTION

It is therefore an object of the invention to provide a resilient spacer for nuclear fuel rods of the type having a plurality of cells to keep the fuel rods in position. The spacer includes two spaced apart grids joined together, with each grid defining cells of the plurality of cells to keep the fuel rods in position and with each cell of the plurality of cells having springs for restricting the displacement of the fuel rods.

It is also an object of the invention to provide a resilient spacer for nuclear fuel rods of the type having a plurality of cells to keep the fuel rods in position. The spacer includes two grids joined together by joint means keeping a spacing between the grids, with each grid defining cells of the plurality of cells to keep the fuel rods in position and with each cell of the plurality of cells having resilient means for restricting the displacement of the fuel rods.

It is still another object of the invention to provide a resilient spacer for nuclear fuel rods of the type comprising a plurality of cells to keep the fuel rods in position. The spacer includes two grids joined together by joint means keeping a spacing between the grids, with each grid defining cells of the plurality of cells to keep the fuel rods in position and with each cell of the plurality of cells having resilient means for restricting the displacement of the fuel rods and wherein the resilient means comprise leaf springs having at least one end thereof bent to form a fold retained in an inner rim of a cell.

It is still another object of the invention to provide a nuclear fuel element having a resilient spacer for nuclear fuel rods, structural tubes, control rods guide tubes and instrumentation tubes, wherein the spacer is of the type comprising a plurality of cells to keep the fuel rods in position. The spacer comprises two grids joined together by joint means keeping a spacing between the grids, with each grid defining cells of the plurality of cells to keep the fuel rods in position and with each cell of the plurality of cells having resilient means for restricting the displacement of the fuel rods.

It is yet another object of the invention to provide a resilient spacer for nuclear fuel rods, with the spacer allowing to reduce, as compared to a resilient spacer of welded plates, the amount of components to be used, the amount of molds that are needed to fabricate the parts and the amount of weldings to achieve the mentioned features.

Furthermore, because of its variable height, weight loss and other structural behavior can be optimized and the elastic constants of the adequate springs can be achieved.

On the other hand, it can be adapted to different geometries of the fuel elements without the need for modifications of the fabrication processes.

Through the mentioned advantages, excellent performance in nuclear service can be achieved during radiation of the fuel elements and their integrity can be guaranteed until their final disposition, once the nuclear service has been finalized.

An additional advantage of the spacer of the invention is that it allows for different types of rods with different diameters to be housed in the same spacer without the need to modify the geometry while the centers of the rods are maintained, only modifying the resting stops and the curvature of the spring.

The resilient spacer of the invention, in contrast with those disclosed in the prior art, is made up of two grids and a set of connection components for each, using bolts and outer skid members, that forms the rigid structure, and together with the resilient springs make up the entire resilient spacer of the invention.

The structure of the grids can be made from discs, bars or plates, using a waterjet cutting machine or machine cutting or a combination of both, which allows for the creation of the part structure in almost definite dimensions, with the possibility of recovering all resulting pieces of material to be used afterwards and avoiding any significant loss of material. This is an essential difference with the spacers of the prior art made through spark erosion, where the removed material becomes irretrievable, which considerably increases the cost of the spacer.

### BRIEF DESCRIPTION OF THE DRAWINGS

In the following section, the invention will be described with reference to exemplary embodiments illustrated in the figures, in which:

FIG. 1 shows a perspective view of the resilient spacer according to a preferred embodiment of the invention;

FIG. 2 shows a perspective view of a real fraction of a nuclear fuel which contains the resilient spacer of FIG. 1, made from Zircaloy, with longitudinal springs;

FIG. 3 shows a perspective view of a grid that forms part of the spacer that is the subject of this invention;

FIG. 4 shows a top plan view of the grid of FIG. 3;

FIG. 5 shows a top plan view of the spacer of the invention, that contains the grid shown in FIG. 4;

FIG. 6 shows a side elevation view of the spacer of the invention;

FIG. 7 shows a perspective view of a rigid spacer of the prior art for circular geometries;

FIG. 8 shows a perspective view of a resilient plated spacer of the prior art for hexagonal geometries, with stamped springs on the plates; and

FIG. 9 shows a perspective view of a portion of a nuclear fuel element that contains a resilient plated separator of the prior art for hexagonal geometries.

### DESCRIPTION OF THE INVENTION

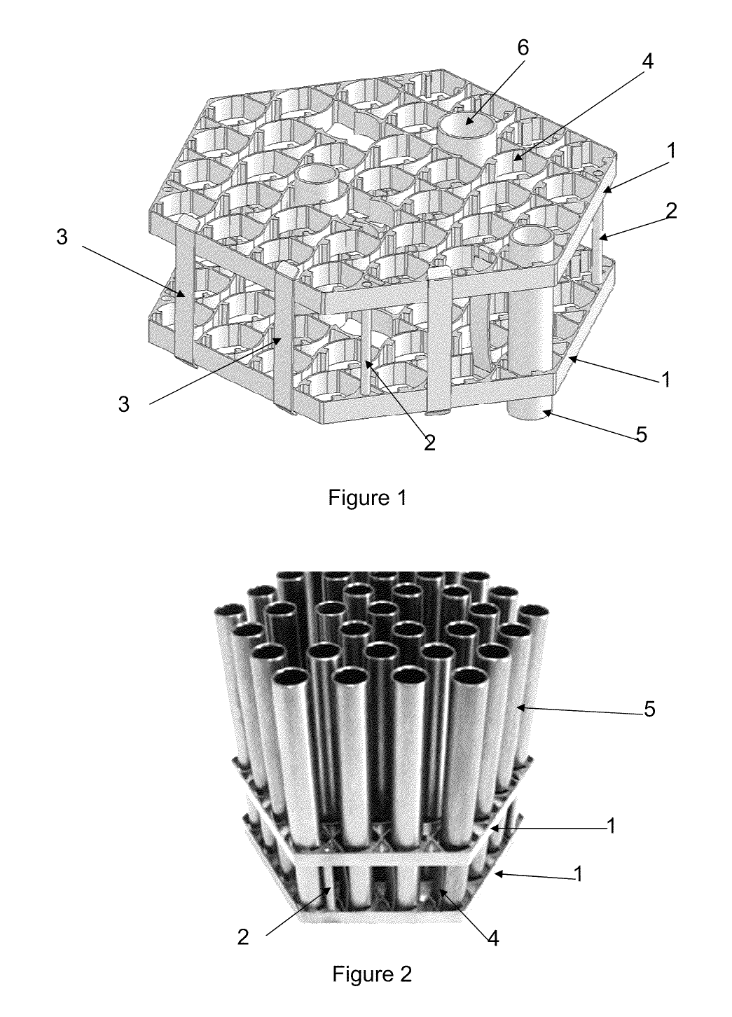

Now referring in detail to the drawings, FIG. 1 shows the inventive resilient spacer comprised of at least two grids 1, rigidly connected to each other by joint means, preferably pins, studs or bolts 2, keeping a spacing between the grids. Each grid, as illustrated, defines cells to keep fuel rods 5 and other nuclear components in position, and the grids are preferably made of Stainless Steel, Inconel or Zircaloy. The number and height of pins 2 should be determined depending on the structural requirements of the spacer. On the external face of this assembly outer skid members 3 may be arranged, for example, welded to the grids. As shown in FIG. 1, the inventive spacer includes resilient means, preferably comprised of longitudinal springs 4 and fuel rods 5, as well as instrumentation tubes or guide tubes 6. The assembly of components configures the rigid structure of the proposed resilient spacer.

In FIG. 2, an actual portion of a nuclear fuel element is shown, for example made from Zircaloy, comprising the resilient spacer as shown in FIG. 1, with two grids 1, pins 2, longitudinal springs 4 and inserted fuel rod sections 5.

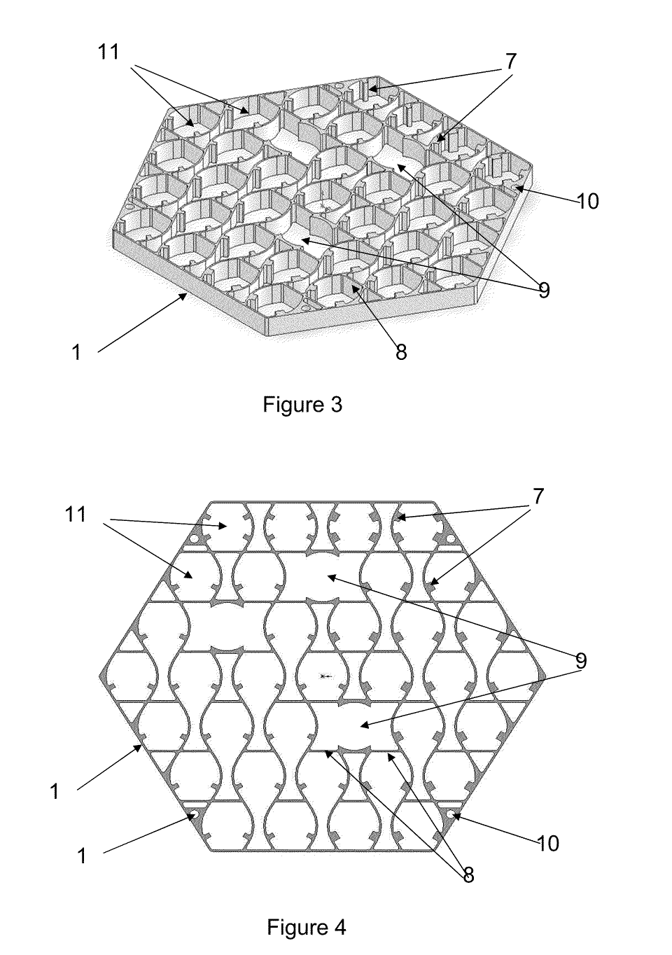

The resilient spacer of the invention, in contrast with those of the prior art, uses two webs or grids 1 as illustrated in FIGS. 3 and 4. These grids 1 are obtained from Zircaloy, Stainless Steel or Inconel discs, bars or plates, depending on the material required for the construction of the resilient spacer and the features it is required to have. On the grids or webs 1, resting stops 7 are installed for support of the fuel rod and rims 8 are also provided for support, assembly and placing of the longitudinal springs, forming the typical cell of each spacer. FIGS. 3 and 4 also show the arrangement of guide tubes 9, through holes 10 for the pins, and the placing of fuel rods 11.

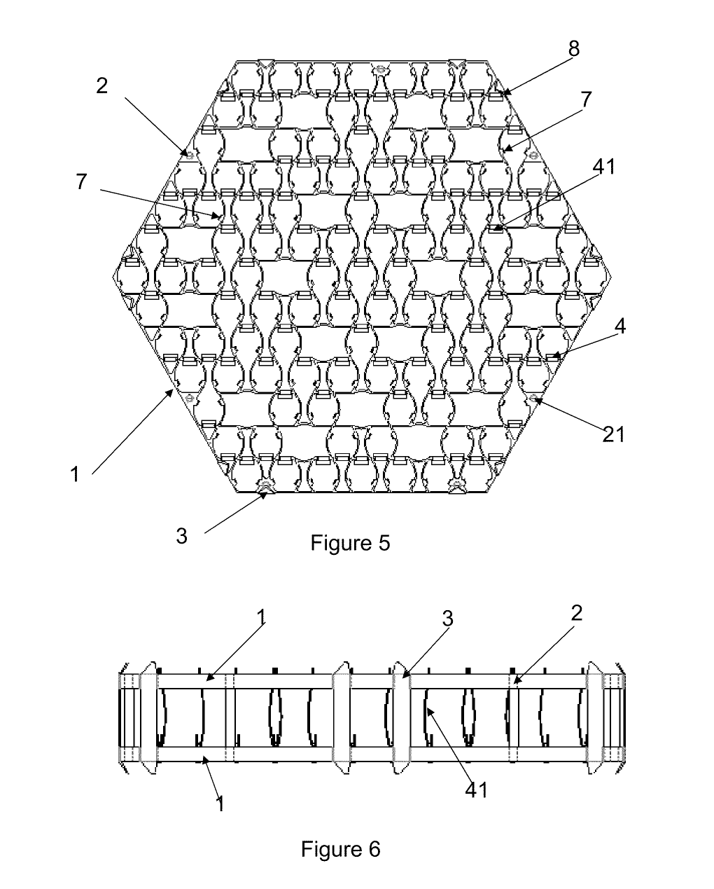

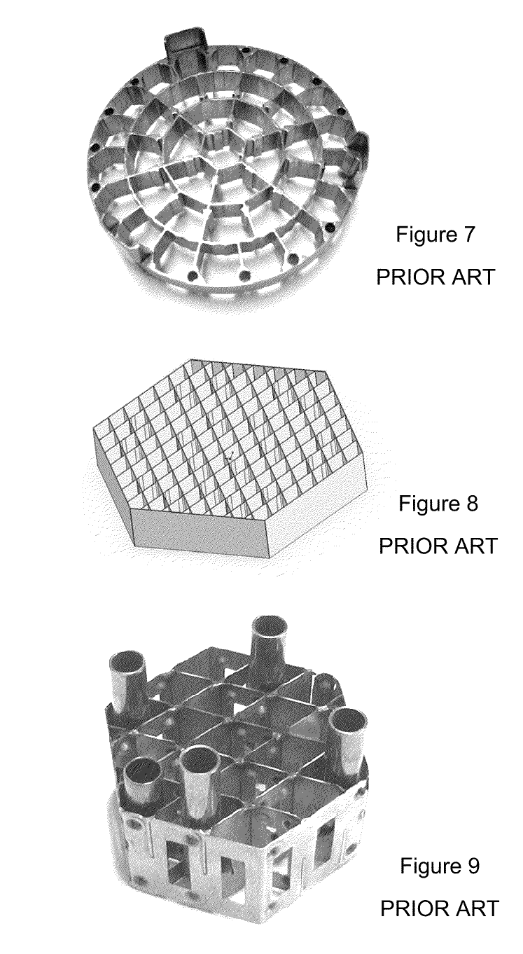

FIG. 5 shows a top plan view of the spacer of the present invention, comprising the grid shown in FIG. 4, together with the remaining components. This hexagonal arrangement or configuration is only one of the possible geometries to be employed for the spacer of the invention. As shown in FIG. 5, pins 2 are positioned properly to connect the two grid plates 1, and springs 4 appear connected to rims 8 of each cell. The cells are provided with resting stops 7 to restrict the movement of the rods and keep them in position. Rims 8 are part of the cell configuration and are also the location where springs 4 are fixed according to the simple but effective construction of the invention. For the implementation of other geometries of fuel elements, the position of rims 8 should be modified, which can be straight or curved in agreement with the adopted design solutions, in order to allow for the required array of the fuel rods.

Skid members 3, as better shown in FIG. 6, are provided in the periphery of the grids and are intended to improve the gliding of the fuel elements during the loading and unloading of the reactor. FIG. 6 also clearly shows pins or studs 2 that fix the distance between the constitutive plates or grids of the spacer and the probable position of the springs or elastics 4 that keep the rod in place. Longitudinal springs 4 can be made of Stainless Steel alloys, Inconel or Zirconium-based alloys and each spring may simply consist of a shaped strap. According to a preferred embodiment, the total height of the spacer is between 10 mm and 70 mm.

Returning to FIG. 1, fuel rods 5 may be seen which are introduced in the corresponding positions and retained by the longitudinal springs. In the other positions, instrumentation or guide tubes 6 are introduced. Through holes 10 are provided in each of grids 1 for the placing and fixation of pins 2 by welding. Pins 2 are housed in different positions that are not occupied by fuel rods 5, and as many pins as necessary can be included in order to achieve structural rigidity of the spacer, in agreement with the features required by the reactor. Therefore, the grids define the necessary locations or housing for structural tubes, control rods guide tubes, instrumentation tubes for conforming the fuel structure and to keep the relative positions of the components, all structured without welded joints or, with almost no welding.

Outer skid members 3 may be provided or not in the outer side or periphery of the grids and, if provided, they may be made of Stainless Steel, Inconel or Zircaloy. Members 3 permit to improve the characteristics of the flow inside of the spacer in agreement with the design needs and furthermore to allow for smooth gliding of one spacer as to another during loading and unloading of the fuel elements of the reactor, in order to avoid any interference between the spacers of bordering fuel elements.

In agreement with what has been described and illustrated above, it has been shown that the spacer of the current invention offers several advantages as discussed above. Furthermore, the fabrication process of the spacer is limited to few parts: plates, elastics or springs, pins and rails, with only some twelve production steps being required. A variable separation between the plates is possible to achieve the elastic constants of the springs necessary for each application and to optimize the loss of charge and other structural behavior. The behavior of the spring is not limited to the height of the spacer as is the case in spacers presented in the past, as this one can be variable without modification of the loss of load of the coolant as a result of the modification of its height. In addition, quality control is easier and furthermore, in case the springs need to be modified, there is no need to discard the entire assembly. The geometry of the section can also be modified without making any changes to the fabrication processes and without any type of investments, as there is no need to make hundreds of molds to produce the plates that make up commonly used spacers. Additionally, different types of rods with different diameters can be housed in the same spacer without the need to modify the geometry while the centers of the rods are maintained, only modifying the resting stops and the curvature of the spring.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed is:

1. A resilient spacer for nuclear fuel rods having a plurality of cells to keep the fuel rods in position, the spacer comprising:
two grids joined together by joint means keeping a spacing between the grids;
wherein each grid defines cells of the plurality of cells to keep the fuel rods in position; and
wherein each cell of the plurality of cells has resilient means for restricting the displacement of the fuel rods.

2. The resilient spacer for nuclear fuel rods according to claim 1, wherein:
the joint means includes welded pins; and
the resilient means includes springs.

3. The resilient spacer for nuclear fuel rods according to claim 2, wherein the springs are metal leaf springs.

4. The resilient spacer for nuclear fuel rods according to claim 3, wherein the leaf springs are bent into a fold in at least one end thereof and are retained in position by their fold ends.

5. The resilient spacer for nuclear fuel rods according to claim 3, wherein outer skid members are arranged in a perimeter of the grids.

6. The resilient spacer for nuclear fuel rods according to claim 3, wherein the cells to keep the fuel rods in position have resting stops to restrict any movement of the rods.

7. The resilient spacer for nuclear fuel rods according to claim 6, further comprising at least one inner straight rim.

8. The resilient spacer for nuclear fuel rods according to claim 5, wherein the cells to keep the fuel rods in position have resting stops to restrict any movement of the rods.

9. The resilient spacer for nuclear fuel rods according to claim 8, further comprising at least one inner straight rim.

10. The resilient spacer for nuclear fuel rods according to claim 9, further comprising at least one inner curved rim.

11. The resilient spacer for nuclear fuel rods according to claim 1, wherein the grids define a housing for components including structural tubes, control rods guide tubes and instrumentation tubes to conform a fuel structure and to keep the relative positions of the components.

12. The resilient spacer for nuclear fuel rods according to claim 3, wherein the grids define a housing for components including structural tubes, control rods guide tubes and instrumentation tubes to conform a fuel structure and to keep the relative positions of the components.

13. The resilient spacer for nuclear fuel rods according to claim 12, wherein the grids have a geometry selected from the group consisting of hexagonal geometry, square geometry and circular geometry.

14. The resilient spacer for nuclear fuel rods according to claim 10, wherein the grids define a housing for components including structural tubes, control rods guide tubes and instrumentation tubes to conform a fuel structure and to keep the relative positions of the components.

15. The resilient spacer for nuclear fuel rods according to claim 14, wherein the spacer has a height between 10 millimeters and 70 millimeters.

16. The resilient spacer for nuclear fuel rods according to claim 15, wherein the grids have a geometry selected from the group consisting of hexagonal geometry, square geometry, and circular geometry.

17. A resilient spacer for nuclear fuel rods having a plurality of cells to keep the fuel rods in position, the spacer comprising:
two grids joined together by joint means keeping a spacing between the grids;
wherein each grid defines cells of the plurality of cells to keep the fuel rods in position;
wherein each cell of the plurality of cells have resilient means for restricting the displacement of the fuel rods; and
wherein the resilient means comprise leaf springs having at least one end thereof bent to form a fold retained in an inner rim of a cell.

18. The resilient spacer for nuclear fuel rods according to claim 17, wherein the cells to keep the fuel rods in position have resting stops to restrict any movement of the rods.

19. A nuclear fuel element and spacer combination, the combination comprising:
a nuclear fuel element comprising:
a plurality of structural tubes;
a plurality of control rods guide tubes; and
a plurality of instrumentation tubes; and
a resilient spacer for nuclear fuel rods having a plurality of cells to keep the fuel rods in position, the spacer comprising:
two grids joined together by joint means keeping a spacing between the grids;
wherein each grid defines cells of the plurality of cells to keep the fuel rods in position; and
wherein each cell of the plurality of cells has resilient means for restricting the displacement of the fuel rods.

20. The combination according to claim 19, wherein:
the joint means includes welded pins;
the resilient means includes metal leaf spring, the leaf springs being bent into a fold in at least one end thereof and are retained in position by their fold ends.

21. The combination according to claim 19, wherein:
the joint means includes welded pins;
the resilient means includes metal leaf springs;
outer skid members are arranged in a perimeter of the grids.
the cells have resting stops to restrict any movement of the rods, thereby keeping the fuel rods in position.
